(19) United States
(12) Patent Application Publication
(10) Pub. No.: US 2020/0119383 A1
(43) Pub. Date: Apr. 16, 2020

(54) BIOMATERIAL ELECTROLYTE FOR AN EVERLASTING BATTERY

(71) Applicant: Energy International Corporation, Canton, MI (US)

(72) Inventors: Rabih Sidnawy, Beirut (LB); Mario El Tahchi, Beirut (LB)

(21) Appl. No.: 16/597,443

(22) Filed: Oct. 9, 2019

Related U.S. Application Data
(60) Provisional application No. 62/771,338, filed on Nov. 26, 2018.

(30) Foreign Application Priority Data
Oct. 10, 2018 (LB) 11536

(51) Int. Cl. H01M 8/16; H01M 2/16; H01M 4/94; H01M 4/96

(52) U.S. Cl. CPC H01M 8/16; H01M 4/96; H01M 4/94; H01M 2/1626

(57) ABSTRACT

A battery and battery electrolyte components are provided including pyocyanin. Methods for making a biomaterial battery include: providing an oxygen permeable anode layer; depositing an oxygenated purified metabolite comprising pyocyanin on the oxygen permeable anode membrane; covering the oxygenated purified metabolite with a bacterial cellulose ion-exchange membrane; depositing a non-oxygenated purified metabolite on the bacterial cellulose ion-exchange membrane; and covering the oxygenated purified metabolite with a cathode layer. The battery is configured to produce a current density of about 3.2 A/m² at constant voltage of about 2.2 V.

### CROSS-REFERENCE TO RELATED APPLICATIONS

This application claims priority to Lebanese Patent Application No. 11536, filed on Oct. 10, 2018, the content of which is incorporated herein by reference in its entirety. This application also claims the benefit of U.S. Provisional Application No. 62/771,338, filed Nov. 26, 2018, the content of which is incorporated herein by reference in its entirety.

### TECHNICAL FIELD

The present disclosure generally relates to battery components and, more particularly, to biomaterial electrolytes for use in batteries.

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly nor impliedly admitted as prior art against the present technology.

Recent industrial policies take into account environmental and financial factors. In addition, technology feasibility and practicability are also important factors that judge the synthesis procedure to be followed during materials preparation.

Various work has been done related to the idea of using microorganisms for electrical power production. The main principle for all of this work is based on the redox reaction that generates electron circulation. The redox reaction is due to the fermentation or the oxidization of a carbon-based nutriment (like glucose) by a bacterium. Several bacteria have been used for this purpose, including Rhodoferax ferrireducens, Shewanella oneidensis, Geobacter, and others.

Chaudhury and Lovley from Institute of Chemistry and Biochemistry, University of Greifswald, Germany, show that Rhodoferax ferrireducens, a metal-reducing bacterium, provides a constant flow of electrons to simple graphite electrodes in a fuel cell while oxidizing glucose or other simple sugars. Electrons generated by R. ferrireducens are easily transferred to the anode without the assistance of electron-shuttling mediators, and the cells grow at a steady rate, which guarantees a steady supply of electrons and therefore a consistent current density. R. ferrireducens burns carbohydrates to CO₂ in the anodic compartment, a process that produces free electrons which are directly captured by the anode. From there, the electrons are channeled to the cathode, where they reduce oxygen to water. The transfer of electrons from the anode to the cathode results in the generation of an electrical current.

On the other side, a team from University of Rochester worked on an Extracellular Electron Transfer on Sticky Paper. Carbon paste paper electrodes (CPPEs) were fabricated by coating a regular paper strip with carbon paste made from graphite powder and mineral oil, followed by coating with polyaniline. The CPPEs were evaluated as anodes in bioelectrochemical cells (BECs) using Shewanella oneidensis MR-1 as bacteria that donate electrons through extracellular electron transfer.

The BEC using the CPPE anode produces current continuously for at least 4 days without the need for additional fuel (lactate). Twenty-four hours after inoculation, the BEC using the CPPE anode generates a current density of 2.2 Am⁻² with an optimal voltage of 0.52 V.

Also, researchers at Binghamton University, State University of New York, have created a bacteria-powered battery on a single sheet of paper. On one half of a piece of chromatography paper was placed a ribbon of silver nitrate underneath a thin layer of wax to create a cathode. The pair then made a reservoir out of a conductive polymer on the other half of the paper, which acted as the anode. Once properly folded and a few drops of bacteria-filled liquid are added, the microbe's cellular respiration powers the battery. Scientists were able to generate 44.85 μW at 105.89 μA in a 6×6 cm configuration.

The following references are provided and incorporated by reference herein in their entirety:
[1] A. Chen, P. K Sen, Advancement in Battery Technology: A State-of-the-Art Review, 2016 IEEE Ind. Appl. Soc. Annual Meet. Portland, Oreg., pp. 1-10, 2016.
[2] A. Fraiwan, S. Mukherjee, S. Sundermier, H. S. Lee, S. Choi, A paper-based microbial fuel cell: Instant battery for disposable diagnostic devices, Biosens. Bioelectron., vol. 49, pp. 410-414, 2013.
[3] S. Li, C. Cheng, A. Thomas, Carbon-Based Microbial-Fuel-Cell Electrodes: From Conductive Supports to Active Catalysts, Adv. Mater., vol. 29, no. 8, pp. 1-30, 2017.
[4] Electricity generation by direct oxidation of glucose in mediatorless microbial fuel cells, Swades K Chaudhuri and Derek R Lovley Nature Biotechnology 21, 1229-1232 (2003) doi:10.1038/nbt867.
[5] Extracellular Electron Transfer on Sticky Paper Electrodes: Carbon Paste Paper Anode for Microbial Fuel Cells, Peter Lamberg and Kara L. Bren, Department of Chemistry, University of Rochester, Rochester, N.Y. 14627-0216, United States, ACS Energy Lett., 2016, 1 (5), pp 895-898, DOI: 10.1021/acsenergylett.6b00435, Publication Date (Web): Oct. 7, 2016.
[6] Yang Gao, Seokheun Choi, Stepping Toward Self-Powered Papertronics: Integrating Biobatteries into a Single Sheet of Paper. Advanced Materials Technologies, 2016; 1600194 DOI: 10.1002/admt.201600194.

### SUMMARY

The main problems that bacterial fuel cells face is their lifetime, efficiency concerning the intensity of the current that they provide and its power, and the ability of being applied in electronic devices as a power supply.

The present technology provides a new bacterial fuel cell that can produce a continuous current of 3.2 Am⁻² at a voltage of 2.2 V. The main principle is based on a redox reaction of pyocyanin, produced by Pseudomonas aeruginosa. At the anode, the O₂ oxidizes the pyocyanin which generates free electrons that are captured by the anode and transferred to the cathode where a reduction reaction takes place.

Regarding the current and voltage values obtained, the battery combines between the high energy density, long life-time cycle and high efficiency of LIB batteries and the eco-friendly trend.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 illustrates the green medium before and after centrifugation according to various aspects of the present technology;

FIG. 2 is an exemplary centrifuge useful with the present technology;

FIG. 3 illustrates (to the left) the yellow solution prepared by air extracting, and (to the right) the green electrolyte prepared by air pumping;

FIG. 4 illustrates the three electrode cell used for the voltammetry study;

FIG. 5 is an exemplary battery design showing five layers;

FIG. 6 is a voltammogram of the green electrolyte; and

FIGS. 7 and 8 are plots showing voltage vs. capacity as discharging characterization and charging characterization graphs.

It should be noted that the figures set forth herein are intended to exemplify the general characteristics of the methods, algorithms, and devices among those of the present technology, for the purpose of the description of certain aspects. These figures may not precisely reflect the characteristics of any given aspect, and are not necessarily intended to define or limit specific embodiments within the scope of this technology. Further, certain aspects may incorporate features from a combination of figures.

### DETAILED DESCRIPTION

Nowadays, daily life is highly dependent on mobile electronic devices and the need of everlasting mobile power sources is increasing. The most common batteries used in modern electronics are lithium ions batteries (LIB) known for their light weight, high energy density and long life cycle. However among the disadvantages of LIB are their relatively high cost and safety hazards. By looking for a greener and safer energy source, electrical power was harvested from microorganism in a microbial fuel cell (MFC). In fact, bacteria can generate electric power by transforming the chemical energy of the biomass to electricity. An important advantage of MFC is that it can be miniaturized and integrated into a thin sheet of paper fulfilling the needs of modern paper electronics. The current density and voltage of such cells ranges from 0.08 to 0.98 A/cm².

The thin battery of the present technology, that uses this MFC, combines LIB high energy density and long life cycle to the eco-friendly trend. The battery of the present technology makes use of a bacterial metabolite that undergoes redox reactions. In various aspects, the approximately 2×5 cm² dimensioned thin battery is composed of 5 layers having a total thickness of about 300 μm. In one exemplary method of making the battery, about 250 μl of an oxygenated purified metabolite (second layer) is deposited on an oxygen permeable anode membrane (first layer) and is covered by a bacterial cellulose ion-exchange membrane (third layer). Another 250 μl of non-oxygenated purified metabolite (fourth layer) is deposited on the bacterial cellulose membrane and covered by the cathode (fifth layer). This structure produced a battery with a current density of about 3.2 A/m² at constant voltage of about 2.2V. The power density does not show any decrease with load and is stable over a 7 days observation period. A voltammogram indicates that the process is reversible and fast. Such values are much higher than those obtained by any bacterial fuel cell. It is important to note that this new battery uses oxygen to create electricity, and releases it back when the electricity is consumed. The battery can be integrated into a thin sheet of paper configured for use with paper electronics. The future development of this green, always-fully-charged battery can lead to their use for mobile devices and electric vehicles.

The present technology generally provides new bacterial fuel cells that can produce a continuous current of 3.2 Am⁻² at a voltage of 2.2 V. The main principle is based on a redox reaction of pyocyanin, produced by Pseudomonas aeruginosa. At the anode, the O₂ oxidizes the pyocyanin, which generates free electrons that are captured by the anode and transferred to the cathode where a reduction reaction takes place.

### Materials and Methods

### Bacteria Growth and Identification

The Pseudomonas aeruginosa can be originated from agriculture waste and isolated on HS agar medium. The yellow agar turns to green after 24 hours of incubation at a temperature of about 28° Celsius. After the HS agar medium turns into green color the bacterium is inoculated in HS liquid medium. After about 48 hours, the medium starts turning green when the flask is agitated.

### Electrolyte Preparation

### Pyocyanin Extraction

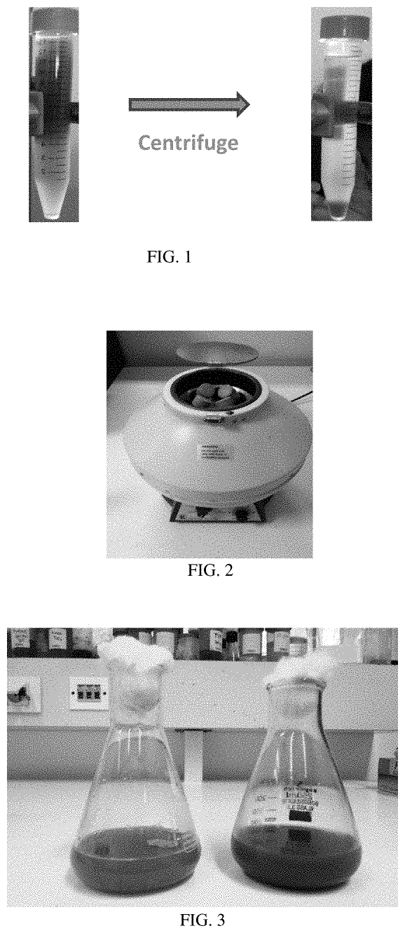

Pyocyanin is extracted from the liquid growth medium using bench top centrifuge. FIG. 1 shows the solution before and after centrifugation.

### Protein Precipitation

The protein precipitation is done using ethanol. After centrifugation, 5% (volume) of ethanol is added to the solution and centrifugation for 5 minutes is applied again. After centrifugation, the solution is heated at 70° C. until 50% of the solution is evaporated.

### Oxygenized/Deoxygenized Electrolyte

Two different electrolytes are prepared: Oxygenized (green electrolyte) and deoxygenized (yellow electrolyte). The green electrolyte is prepared by bubbling air in the solution, while the yellow electrolyte is prepared by extracting the oxygen from the solution using a vacuum pump. FIG. 3 shows the 2 different electrolytes prepared.

### Electrochemical Study

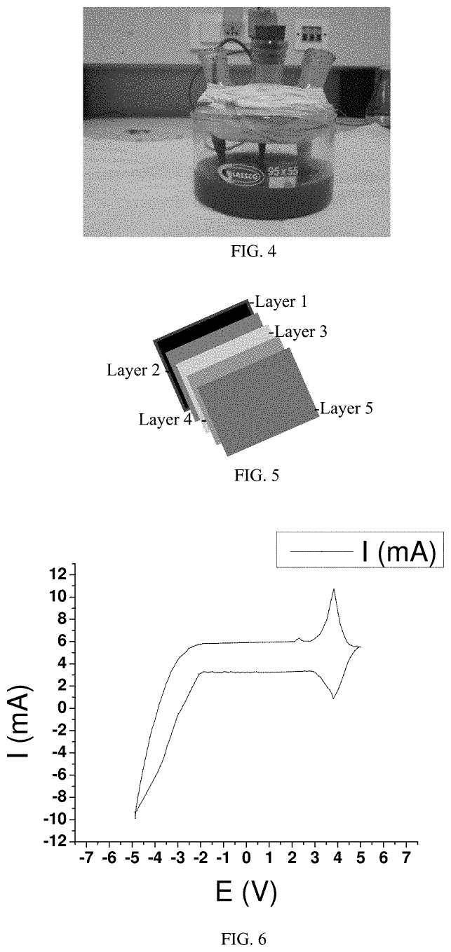

A voltammetry study is done on the green electrolyte using a 3 electrode cell. Electrodes used and the voltammetry properties are shown in FIG. 4 and provided below. The working electrodes are carbon and copper. The reference electrode is AgCl. Voltammetry properties are as follows:

Potential sweep: v=90 mV/s

Potential range: [−5V; +5V]

Number of cycles: 3

Thin Battery Design

The thin battery is composed of 5 layers as illustrated in FIG. 5. Layer 1: carbon layer that serve as a cathode (bottom layer); Layer 2: 0.25 ml of green electrolyte, also referred to as the oxygenized electrolyte layer; Layer 3: separator membrane from bacterial cellulose (middle layer); Layer 4: 0.25 ml of yellow electrolyte, also referred to as the deoxygenized electrolyte layer; and Layer 5: copper layer as anode (top layer). The battery dimensions are 2×5×0.03 cm³.

### Charging and Discharging Characterization

In order to evaluate the charging and discharging capacity of the battery, a cell is cyclically charged and discharged at a constant low current and between upper and lower voltage limit. The cell is first charged at a constant current rate to the upper voltage limit. After charging, the input current is set to zero for 10 minutes. Then, the cell is discharged to the lower voltage limit.

### Results and Discussions

### Voltammetry Study

The voltammogram in FIG. 6 shows 2 peaks: an anodic peak Eₚₐ at 3.83V and a cathodic peak Eₚₐ at 3.8V. The intensities of the peaks are: Ipa=4.62 mA for Eₚₐ and Ipc=4.61 mA for E_{pc}.

TABLE 1
Potential and Current Values at the Peaks.

| | |
|---|---|
| Eₚₐ (V) | 3.83 |
| E_{pc} (V) | 3.80 |
| Ipa (mA) | 4.62 |
| Ipc (mA) | 4.61 |

Regarding Nernst equation, to have a reversible reaction, the values of the potentials and the currents should respect the below equations:

$$Δ {E}_{p} = \vert {E}_{pa} - {E}_{pc} \vert = \frac{0.059}{n} ;$$

n: nb. of electrons gained by reduction

$$\frac{{I}_{pc}}{{I}_{pa}} = 1$$

Applying our values in those 2 equations we find that ΔEₚ=|Eₚₐ−E_{pc}|=0.03 and

$$\frac{{I}_{pc}}{{I}_{pa}} = 1$$

Regarding those results, the reaction that take place is a reversible reaction with 2 electrons transfer during the reduction.

### Thin Battery Characteristics

Table 2, provided below, lists various characteristics of the thin battery of the present technology. In particular, the battery characteristics show that the battery according to the present technology has a high energy density and small dimensions, and it respects the ecofriendly trend. Regarding those values, this biomaterial battery can be the future technology for battery industry that generates electrical energy better than any other renewable source of energy and can be adopted and personalized to be used for all electronics devices and vehicles.

TABLE 2
Battery Characteristics

| | |
|---|---|
| Current (A/m²) | 3.2 |
| Voltage (V) | 2.2 |
| Toxicity | Non toxic |
| Dimensions (cm³) | 2 × 5 × 0.03 |
| Operating temperature (C.) | [−20; 120] |
| Heat emission | no |

### Charging and Discharging Characteristics

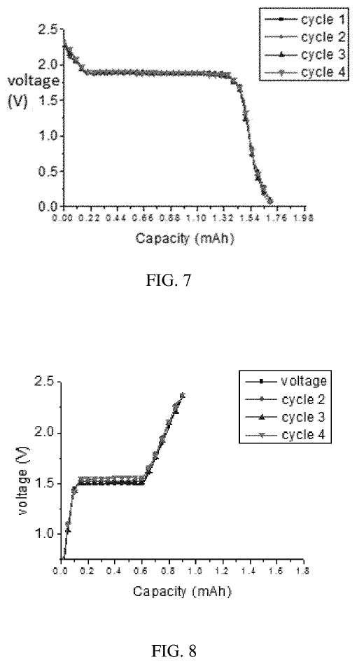

FIGS. 7 and 8 illustrate the charging and discharging characterizations of the biomaterial cell. The discharging characterization is identical for a Lithium ion battery; approximately they both have the same time of discharging and internal resistance. Concerning the charging characterization, the biomaterial battery charges faster than an ordinary Li ion battery.

The foregoing description is provided for purposes of illustration and description and is in no way intended to limit the disclosure, its application, or uses. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range, including the endpoints.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

What is claimed is:

1. A battery comprising:
a cathode comprising carbon;
a first electrolyte layer;
a separator membrane comprising bacterial cellulose;
a second electrolyte layer; and
an anode comprising copper,
wherein at least one of the first electrolyte layer and the second electrolyte layer comprises pyocyanin.

2. The battery according to claim 1, wherein the pyocyanin is harvested from Pseudomonas Aeruginosa.

3. The battery according to claim 1, wherein the first electrolyte layer comprises an oxygenized electrolyte, and the second electrolyte layer comprises a deoxygenized electrolyte.

4. The battery according to claim 1, integrated into a thin sheet of paper configured for use with paper electronics.

5. The battery according to claim 1, comprising an area (length and width) dimension of about 2×5 cm², wherein the battery is provided with a total thickness of about 300 μm.

6. The battery according to claim 1, configured to produce a current density of about 3.2 A/m² at constant voltage of about 2.2 V.

7. The battery according to claim 1, wherein oxygen is added to create electricity, and oxygen is released when the electricity is consumed.

8. The battery according to claim 1, wherein the first electrolyte and second electrolyte are free from Pseudomonas Aeruginosa.

9. A method of making a biomaterial battery, the method comprising:
providing an oxygen permeable anode layer;
depositing an oxygenated purified metabolite comprising pyocyanin on the oxygen permeable anode membrane;
covering the oxygenated purified metabolite with a bacterial cellulose ion-exchange membrane;
depositing a non-oxygenated purified metabolite on the bacterial cellulose ion-exchange membrane; and
covering the oxygenated purified metabolite with a cathode layer.

10. The method according to claim 9, wherein the anode comprises copper, and the cathode comprises carbon.
